(19) United States
(12) Patent Application Publication
(10) Pub. No.: US 2025/0381516 A1
(43) Pub. Date: Dec. 18, 2025

(54) AMINE AND AMMONIUM MODIFIED SILICONES FOR DIRECT AIR CAPTURE OF CARBON DIOXIDE

(71) Applicants: Matthew Green, Phoenix, AZ (US); Klaus Lackner, Longmont, CO (US); Jae Sang Lee, Tempe, AZ (US); Taysha Bonham Likes Telenar, Queen Creek, AZ (US)

(72) Inventors: Matthew Green, Phoenix, AZ (US); Klaus Lackner, Longmont, CO (US); Jae Sang Lee, Tempe, AZ (US); Taysha Bonham Likes Telenar, Queen Creek, AZ (US)

(21) Appl. No.: 19/230,971

(22) Filed: Jun. 6, 2025

Related U.S. Application Data
(60) Provisional application No. 63/657,496, filed on Jun. 7, 2024.

(51) Int. Cl. B01D 53/14; B01D 71/70; B01J 20/22; B01J 20/28

(52) U.S. Cl. CPC B01D 53/1475; B01D 71/70; B01J 20/22; B01J 20/28033

(57) ABSTRACT

An additive-modified membrane includes a functionalized siloxane and an additive that modifies the structure of the functionalized siloxane. The functionalized siloxane is cross-linked. The additive-modified membrane is configured to capture gas molecules, the additive increases a solubility of the gas molecules in the additive-modified membrane, and increasing the solubility of the gas molecules in the additive-modified membrane includes increasing the permselectivity of the additive-modified membrane. A CO₂ capture system including the additive-modified membrane in contact with a CO₂ absorbent is configured to capture CO₂ from an atmosphere.

### CROSS-REFERENCE TO RELATED APPLICATION

This application claims the benefit of U.S. application No. 63/657,496 entitled “AMINE AND AMMONIUM MODIFIED SILICONES FOR DIRECT AIR CAPTURE OF CARBON DIOXIDE” and filed on Jun. 7, 2024, which is incorporated herein by reference in its entirety.

### TECHNICAL FIELD

This invention relates to a hybrid carbon dioxide capture and transformation system for separation and in situ resource utilization of atmospheric carbon dioxide.

### BACKGROUND

Direct air capture of carbon dioxide involves the capture of carbon dioxide directly from air. The carbon dioxide can be captured from air by physical or chemical means, and the captured carbon dioxide can be sequestered or recycled for use in subsequent processes.

### SUMMARY

This disclosure relates to a carbon dioxide (CO₂) capture process utilizing functionalized siloxane membranes, including modified polydimethylsiloxane (PDMS) and polymethylhydrosiloxane (PMHS). The functionalized siloxane membranes can be modified with primary, secondary, tertiary amines or any combination thereof to provide CO₂ binding and regeneration. The CO₂ capture process can include a thermal system packed with sorbents such as amine-based sorbents and can include temperature, pressure, vacuum adsorption-desorption cycles for CO₂ capture. The system can include a modular CO₂ capture process that can function under various CO₂ concentrations and ambient pressures. The CO₂ capture process can include a single stage or multi-stage separation process to increase CO₂ flux and permeate concentration.

In a first general aspect, an additive-modified membrane includes a functionalized siloxane, and an additive that modifies the structure of the functionalized siloxane. The functionalized siloxane is cross-linked. The additive-modified membrane is configured to capture gas molecules. The additive increases a solubility of the gas molecules in the additive-modified membrane, and increasing the solubility of the gas molecules in the additive-modified membrane includes increasing the permselectivity of the additive-modified membrane.

Implementations of the first general aspect may include one or more of the following features.

The additive-modified membrane where the functionalized siloxane includes:

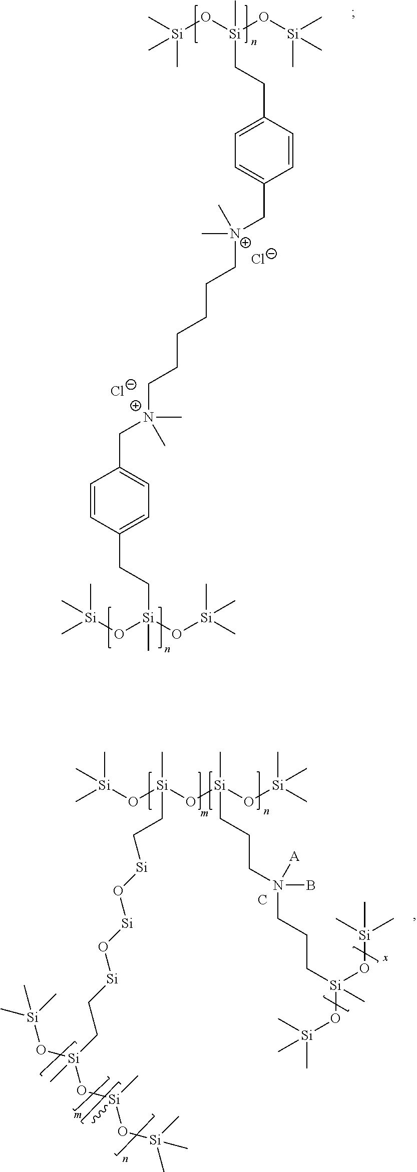

wherein A is hydrogen and B and C are not present, or
wherein A is a methyl group and B and C are not present, or
wherein A is a methyl group, B is a methyl group, and C is a counterion;

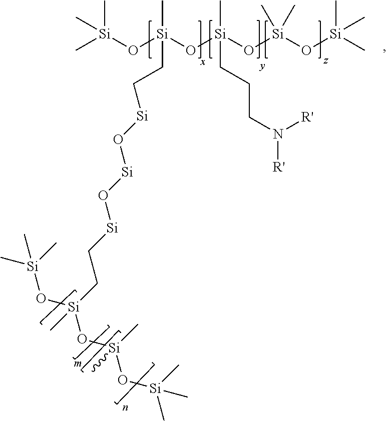

wherein each R′ independently comprises a methyl group or a hydrogen;

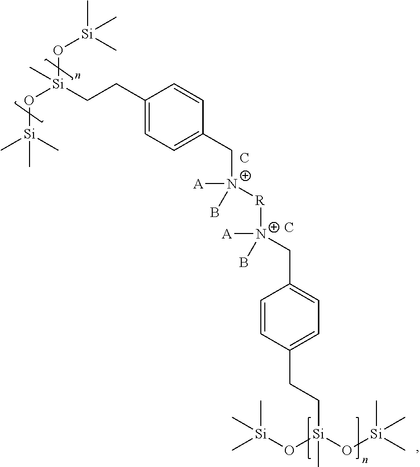

wherein R comprises

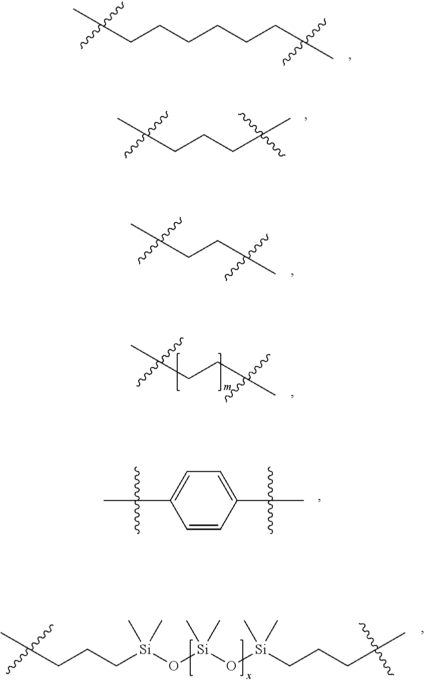

wherein A is hydrogen and B and C are not present, or
wherein A is a methyl group and B and C are not present, or
wherein A is a methyl group, B is a methyl group, and C is a counterion;

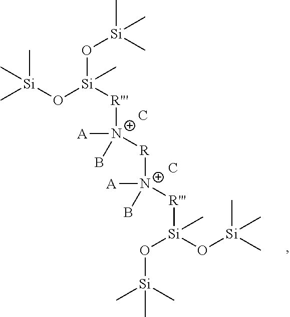

wherein R″ is

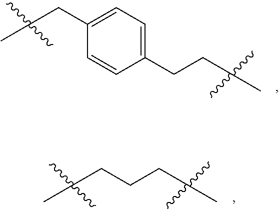

wherein A is hydrogen and B and C are not present, or
wherein A is a methyl group and B and C are not present, or
wherein A is a methyl group, B is a methyl group, and C is a counterion;

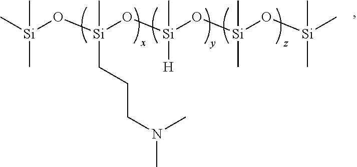

or any combination thereof,
wherein the counterion comprises a halide, a fluorinated anion, or an alkaline anion,
wherein the halide is Cl⁻, Br⁻, or I⁻,
wherein the fluorinated anion comprises

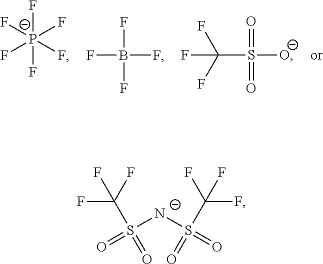

wherein the alkaline anion comprises OH⁻, HCO₃⁻, or CO₃⁻², and
wherein m, n, w, x, y, z are integers.

The functionalized siloxane can include polydimethylsiloxane, polymethylhydrosiloxane, or both. In some cases, the additive is an amine (e.g., a tertiary amine or a quaternary amine). Examples of suitable amines include N,N,N′,N′-tetramethylhexane-1,6-diamine; vinyl-quaternary ammonium methacrylate siloxane; N,N-dimethylallylamine; quaternary ammonium methyl siloxane; or any combination thereof.

The gas molecules can include CO₂. The additive-modified membrane can chemisorb the CO₂. The additive-modified membrane can be semipermeable.

In a second general aspect, a CO₂ capture system includes the additive-modified membrane of the first general aspect and a CO₂ absorbent. The additive-modified membrane is in contact with the CO₂ absorbent.

Implementations of the second general aspect may include one or more of the following features.

The CO₂ absorbent can be in direct contact with or wrapped in the additive-modified membrane. The CO₂ absorbent is in direct contact with the additive-modified membrane. Examples of suitable CO₂ absorbents include an amine-based sorbent, soil, or a combination thereof. In some cases, the CO₂ capture system includes a single stage configured to yield permeate concentrations of more than about 99.9% CO₂. In certain cases, the CO₂ capture system includes multiple stages configured to yield permeate concentrations of more than about 99.9% CO₂. The multiple stages can be multiple single stages configured in series or parallel.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic of a gas permeation unit that controls feed composition, pressure ratio, and flow rate.

FIGS. 2A-2B are an example reaction schematic for making an amine-modified functionalized siloxane.

FIG. 3 is an example reaction schematic for making an amine-modified functionalized siloxane.

FIGS. 4A-4D are schematics of exemplary ammine and di-quaternary ammonium salt bridges.

### DETAILED DESCRIPTION

This disclosure describes a hybrid carbon dioxide (CO₂) capture and transformation system for separation and in situ resource utilization of atmospheric CO₂. As used herein, gas concentration in terms of “%” refers to volume percent. The system captures CO₂ from an atmosphere and transforms the captured CO₂ into valuable resources that may be used, for example, to sustain space exploration technologies and sustenance. The system may include an additive-modified membrane. For example, existing heating, ventilation, and air conditioning (HVAC) systems can be retrofitted with the additive-modified membrane to increase CO₂ capture. The additive-modified membranes can include a functionalized siloxane and an additive that modifies the functionalized siloxane. The additive-modified membranes can be a functionalized siloxane membrane (e.g., modified polydimethylsiloxane (PDMS), modified polymethylhydrosiloxane (PMHS), or a mixture of modified PDMS and modified PMHS. In some constructions, the additive-modified membrane chemisorbs CO₂. The additive-modified membrane is semipermeable.

An implementation of the CO₂ capture system described herein includes a thermal system packed with highly effective CO₂ absorbents in contact with, or wrapped in, one or more additive-modified membranes. The additive-modified membranes can be in direct contact with the CO₂ absorbents. Several bundles of the additive-modified membranes and CO₂ absorbents can be selected to undergo temperature, pressure, and vacuum adsorption-desorption cycles for separation and capture of CO₂ in a device that resembles a heat exchanger. Suitable CO₂ absorbents include amine-based sorbents and soil. Detailed material characterization and dynamic CO₂ capture performance studies in the disclosed system can be used to tailor the size, weight, and performance of the CO₂ capture and transformation system.

A staged membrane-based separation process that concentrates CO₂ from ambient air (1 bar, 0.04% CO2) with modest energy inputs can be adapted to purify CO₂ with a wide range of feed concentrations and absolute pressures by tuning the membrane characteristics and the operating conditions (including temperature, the ratio between the feed and permeate pressure (e.g., the pressure ratio), and the ratio between the feed and permeate flow rates (e.g., the stage cut)). One example includes amine and ammonium groups to increase the solubility of CO₂ in a functionalized siloxane membrane to increase the enrichment concentration.

The CO₂ capture system can be a modular system. Experimental studies are designed to explore the effect of feed pressure and CO₂ concentration (from 0.0065-1 bar and 0.04-95%), along with the impact of operating temperature on CO₂ flux and permeate concentration for a multi-stage separation scheme, with the permeate pressure set lower than the feed pressure to establish a pressure ratio of feed pressure ranging from 5-1,000 times greater than the permeate pressure. At feed pressures of ˜1 bar and CO₂ partial pressures typical of ambient Earth conditions, the separation is expected to be pressure ratio limited. A pressure ratio limited separation provides that the permeate concentration may be due at least in part to the depth of vacuum on the permeate side, and then stage cut can be used to determine the fraction of CO₂ that is captured from the feed.

At CO₂ partial pressures such as at 95% CO₂, the system can be expected to be membrane permselectivity limited. In one example, a single pass through the functionalized siloxane membrane can yield permeate concentrations of >99.9% CO₂. In one example, the relevant absolute pressures can be lower than ambient conditions (e.g., ˜6.5 mbar). If a deeper vacuum is utilized, energy-efficiency may be a factor. The stage cut (fraction of CO₂ from the feed to the permeate) may impact the energy-efficiency of the separation process. The operating conditions may vary to address high CO₂ partial pressures or lower absolute pressures to achieve energy efficiency, but the modular system is suitable for both scenarios.

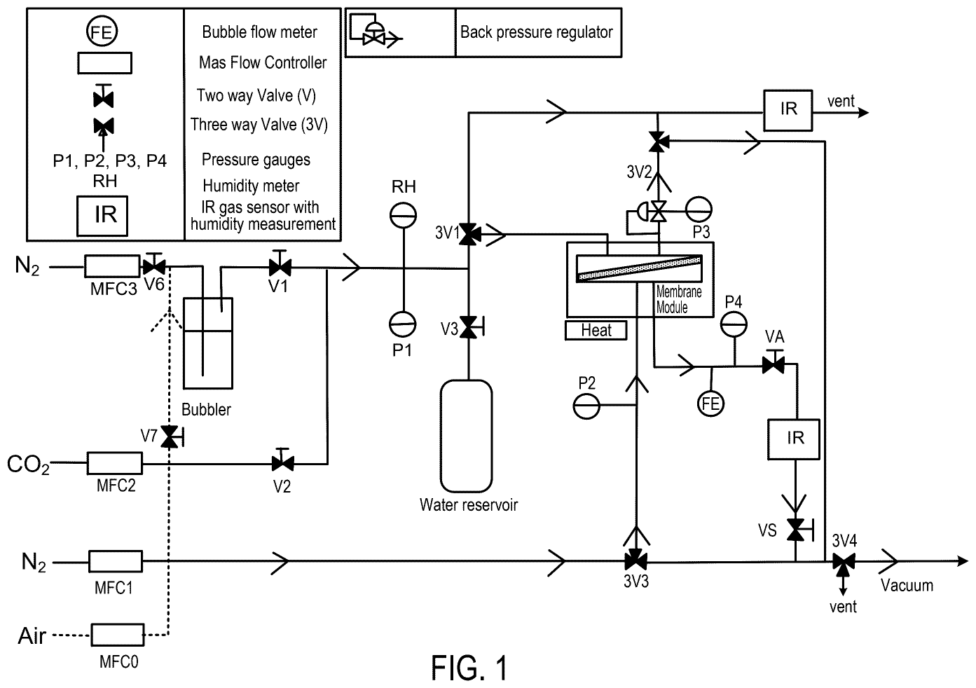

Some implementations include a single stage process which can be suitable for high CO₂ partial pressures. The resulting data can be fed into a multi-stage process model. Other implementations include a staged process for low CO₂ partial pressures. The modular system can include a design that allows the process to contain serial stages or to have multiple single stages that run in parallel. FIG. 1 is a schematic of the apparatus suitable for gas separation experiments.

In some implementations, an additive-modified membrane is a functionalized siloxane membrane modified with amines. Amines and ammonium functional groups are added to functionalized siloxane backbones, and the resulting polymers are cast into membranes. The amine-modified functionalized siloxane membranes bind to CO₂ via chemisorption, and thus modify the permselectivity of the functionalized siloxane membranes. In some implementations, the amine includes a primary, secondary, or tertiary amine, and/or a quaternary amine. Examples of the amine utilized include N,N,N′, N′-tetramethylhexane-1,6-diamine; vinyl-quaternary ammonium methacrylate siloxane; N,N-dimethylallylamine; quaternary ammonium methyl siloxane; or any combination thereof. Amines are believed to increase the CO₂ solubility in the membranes. Regeneration of the additive-modified membranes, such as the amine-modified functionalized siloxane membranes, may be advantageous at least in part because the amines chemically bind to the CO₂.

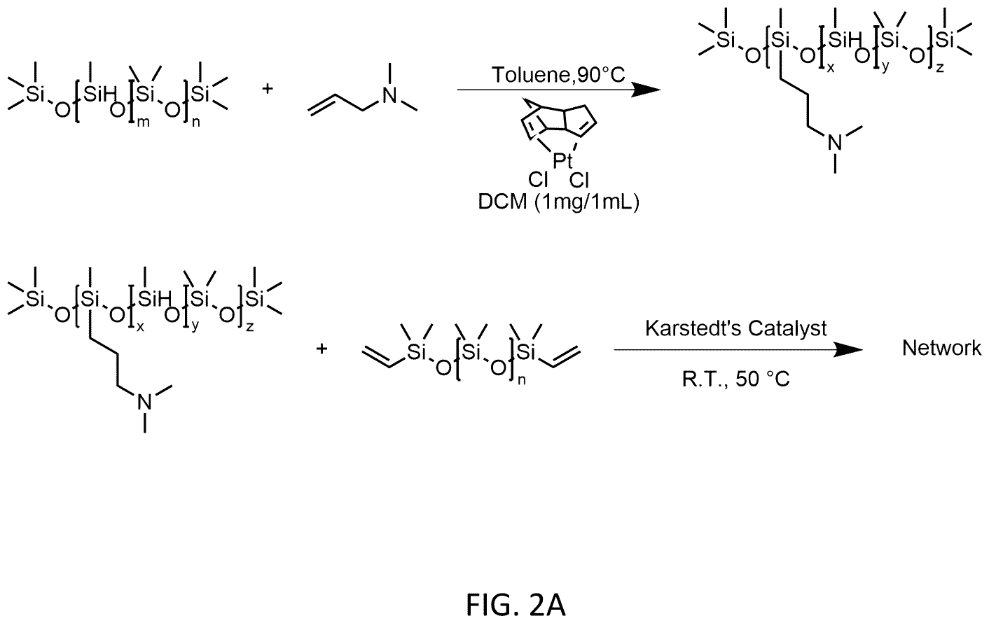

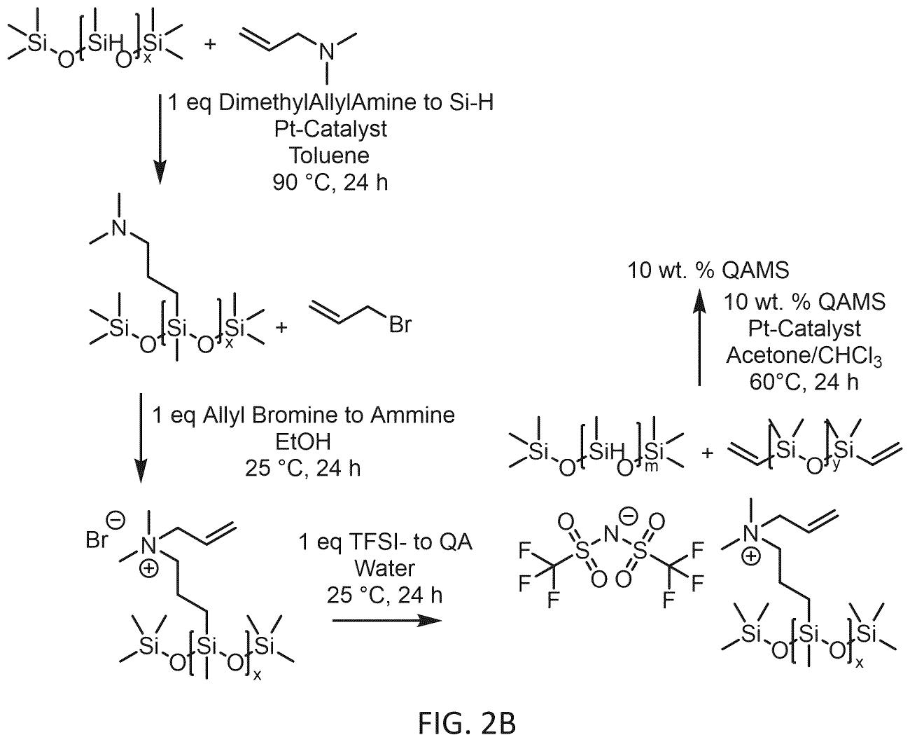

FIGS. 2A and 2B show an example of a reaction scheme suitable for making the amine-modified functionalized siloxane. The reaction scheme shows a tertiary amine attached to the functionalized siloxane to yield a quaternary amine polymer.

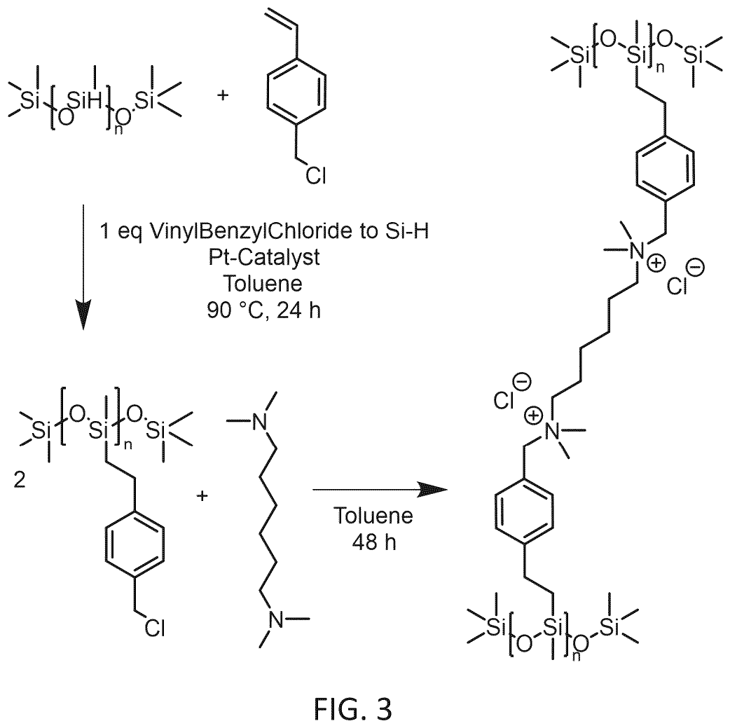

FIG. 3 shows an example of a reaction scheme suitable for making the amine- modified functionalized siloxane. The reaction scheme shows a vinylbenzylchloride and a diamine (e.g., N,N,N′,N′-tetramethylhexane-1,6-diamine) attached to the functionalized siloxane to produce a functionalized siloxane separated by a di-quaternary ammonium salt bridge. The diamine attached to the functionalized siloxane can include varying number of carbons. For example, the diamine bridge may include e.g., N,N,N′, N′-tetramethylethylene-1,2-diamine, N,N,N′,N′-tetramethylpropylene-1,3-diamine, N,N,N′,N′-tetramethylbutylene-1,4-diamine, N,N,N′,N′-tetramethylpentylene-1,5-diamine.

The functionalized siloxane can include PDMS instead of, or in addition to, the hexane bridge between the two quaternary ammonium salts. The functionalized siloxane can include a phenyl moiety instead of, or in addition to, the hexane bridge between the two quaternary ammonium salts. In one example, the quaternary ammonium salt bridge is N,N,N′,N′-tetramethyl-1,4-phenylenediamine.

The functionalized siloxane may also be modified with primary, secondary, tertiary, and/or quarternary amines, which have different binding affinities for CO₂, and which may require different regeneration temperatures.

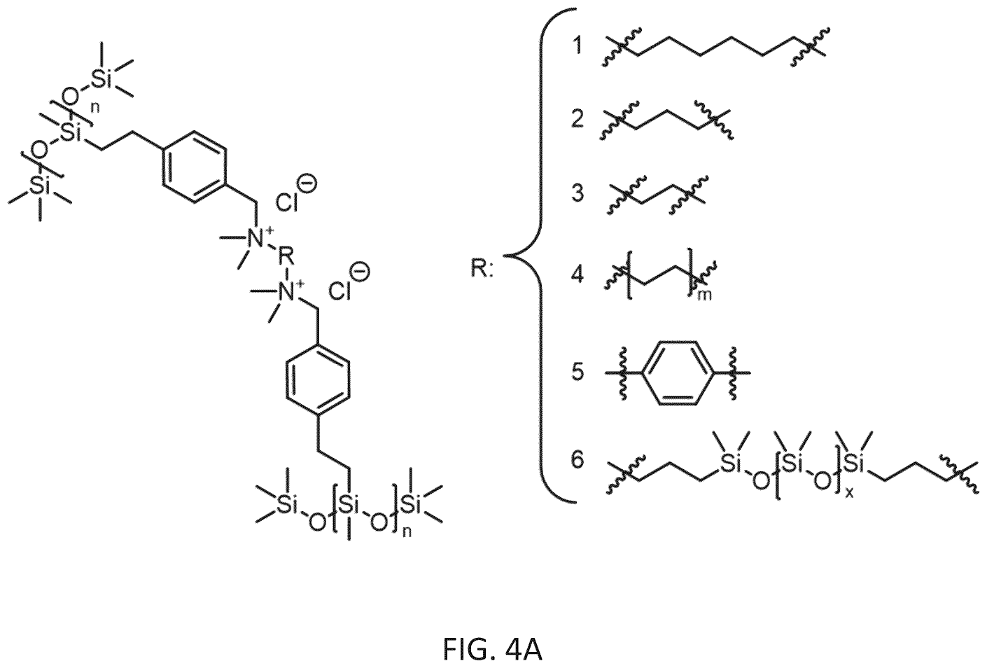

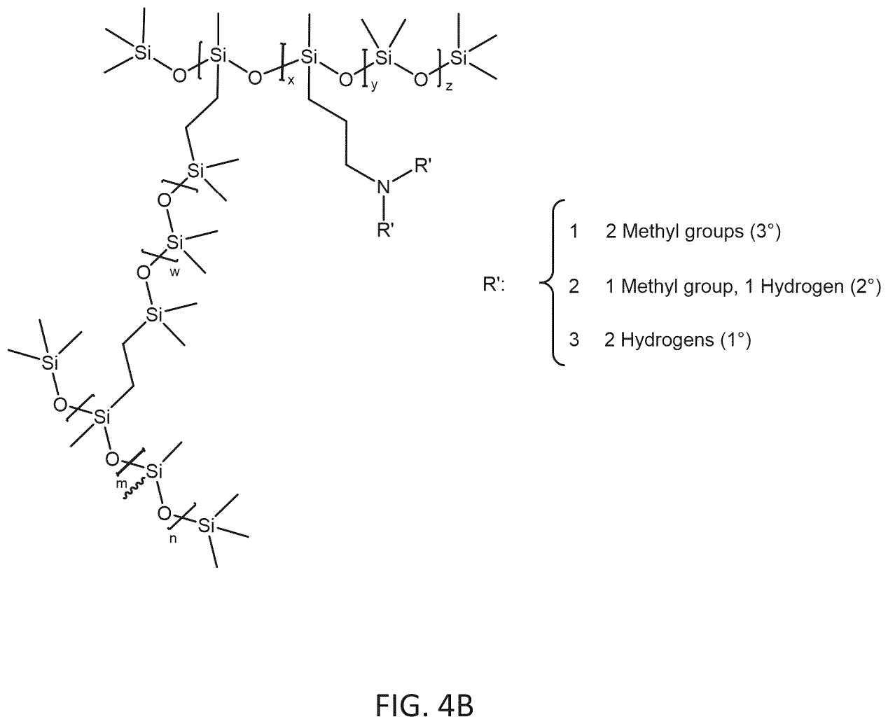

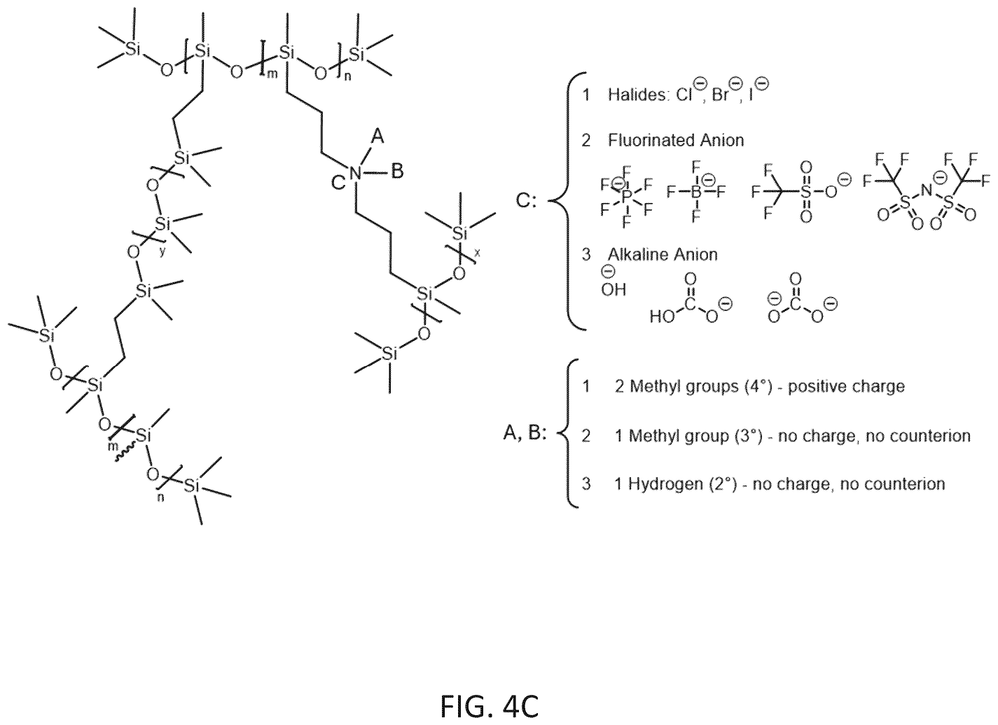

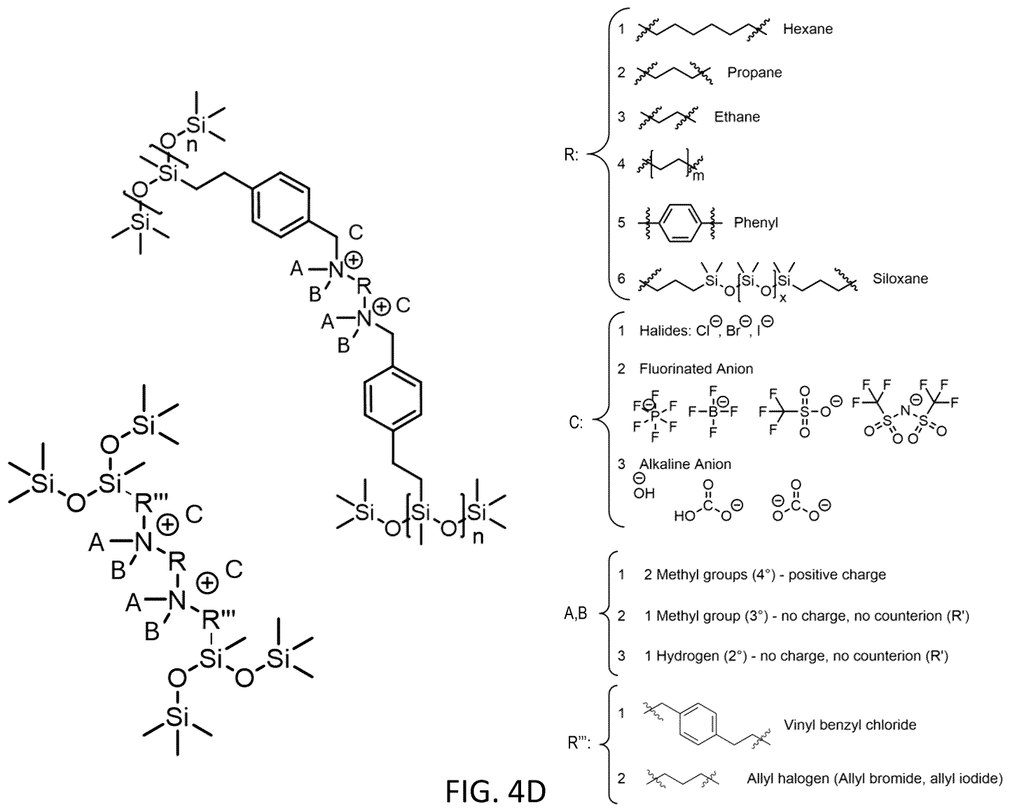

FIGS. 4A and 4B show exemplary di-quaternary ammonium salt bridges which can be used. In FIGS. 4A and 4B, m, n, and x are non-zero integers.

In FIG. 4A, R1 is a 6-carbon bridge between the quaternary ammonium salts, poly(4-(ethyl,benzyl)-N¹, N¹, N⁶, N⁶-tetramethylhexane-1,6-diammonium, methyl siloxane) (PEBHAMS). R2 is a 3-carbon bridge between the quaternary ammonium salts, poly(4-(ethyl,benzyl)-N¹, N¹, N³, N³-tetramethylpropyl-1,3-diammonium, methyl siloxane) (PEBPAMS). R3 is a 2-carbon bridge between the quaternary ammonium salts, poly (4-(ethyl,benzyl)-N¹, N¹, N², N²-tetramethylethyl-1,2-diammonium, methyl siloxane) (PEBEAMS). R4 is a schematic providing for various length carbon chain bridges between the quaternary ammonium salts, poly(4-(ethyl,benzyl)-N¹, N¹, N^{2m}, N^{2m}-tetramethyl (polyethylene)-1,2m-diammonium, methyl siloxane) (PEBPEAMS), wherein m is an integer. In some embodiments, m is in a range of about 2 to about 10. R5 is a phenyl bridge between the quaternary ammonium salts, poly(4-(ethyl,benzyl)-N¹, N¹, N⁴, N⁴-tetramethylphenyl-1,4-diaminium, methyl siloxane) (PEBPhAMS). R6 is a PDMS bridge between the quaternary ammonium salts, poly(bis-(4-(ethyl,benzyl)-N, N-dimethylpropylaminium, methyl siloxane)-dimethyl siloxane) (PBEBAMS). In some embodiments, m is in a range of about 2 to about 10, n is in a range of about 20 to about 45, and x is in a range of about 5 to about 850. Any length of m allowing the diamine bridge to be soluble in toluene or chloroform is contemplated.

In FIG. 4B, an amine functionalized siloxane is shown each R′ is independently a methyl group or a hydrogen, and m, n, w, x, y, z are non-zero integers. In some embodiments, m and n are in a range of about 10 to about 45; x, y, and z are in a range of about 5 to about 850; and w is in a range of about 9 to 2,000. Any length of m allowing the diamine bridge to be soluble in toluene or chloroform is contemplated.

In FIG. 4C, quaternary ammonium functionalized siloxanes are shown. In one example, A is a hydrogen or a methyl group, and B and C are not present. In another example, A is a methyl group, B is a methyl group, and C is a counterion. In FIG. 4C, m, n, and x are non-zero integers, where m is in a range of about 2 to about 10, n is in a range of about 20 to about 45, x is in a range of about 5 to about 850, and y is in a range of about 9 to 2,000. Any length of m allowing the diamine bridge to be soluble in toluene or chloroform is contemplated.

In FIG. 4D, quaternary ammonium functionalized siloxanes are shown. In one example, A is a hydrogen or a methyl group, and B and C are not present. In another example, A is a methyl group, B is a methyl group, and C is a counterion. In FIG. 4D m, n, and x are non-zero integers, where m is in a range of about 2 to about 10, n is in a range of about 20 to about 45, and x is in a range of about 5 to about 850. Any length of m allowing the diamine bridge to be soluble in toluene or chloroform is contemplated.

### EXAMPLES

### Reaction 1

For a 5 g batch of amine-modified PDMS membrane: 15.267 g N,N-dimethylallylamine and 10 g polyhydromethylsiloxane (PHMS) were reacted in 100 mL Toluene, 2 mL dichloromethane with a 11.2 mg of dichloro(dicyclopentadienyl(platinum (II))) catalyst (250 ppm) in an inert N₂ environment to yield poly(3-dimethylaminopropyl) methylsiloxane. The poly(3-dimethylaminopropyl) methylsiloxane was then reacted with allyl bromide to yield a quaternary ammonium salt modified PDMS, where the anion is a bromide. Next the bromide anion is ion exchanged with a TFSI⁻ ion in 25° C. water for 24 hours to allow the quaternary ammonium salt modified PDMS to be soluble in a CHCl₃/acetone mixture. A fourth step combines the vinyl-quaternary ammonium methyl siloxane with additional PHMS and vt-PDMS. Subsequently the reaction components are filtered through diatomaceous earth (Celite), the tolune is removed using a rotovap and the reaction product is dried in the a vacuum oven at 50° C. for 2 days. Other suitable anions include hexafluorophosphate ([PF₆]⁻), tetrafluoroborate ([BF₄]⁻), trifluoromethanesulfonate ([F₃CSO₃]⁻), or bistriflimide ([(CF₃SO₂)₂N]⁻).

### Reaction 2

0.1915 g polyhydromethylsiloxane (PHMS), 4.28 g vinyl-terminated polydimethylsiloxane (vt-PDMS), and 0.5 g vinyl-quaternary ammonium methacrylate siloxane (v-QAMS) were combined in a 2000 μL acetone: 400 μL chloroform solution. In another vial, 25 μL Karstedt's Catalyst in vt-PDMS was combined with a 400 μL acetone: 200 μL chloroform. The two vials were combined, and the resulting mixture was poured into a TEFLON mold. The curing process was completed in two methods: either immediately place the TEFLON mold into a cold oven set at 70° C. overnight; or place the TEFLON mold into a hood overnight to remove bubbles, then place the TEFLON mold into a 70° C. oven overnight.

### Reaction 3

Vinylbenzyl chloride polydimethylsiloxane (VBC-PDMS) is dissolved in toluene. Sufficient diamine (e.g., N,N,N′,N′-tetramethylhexane-1,6-diamine) is mixed in to create a crosslinked network. At room temperature, the reaction is allowed to proceed for approximately 48 hours. The solution is then poured into a TEFLON dish and left for 48 hours. During this period, toluene evaporates when the dish is placed in a hood.

In a continuous implementation, a sinusoidal temperature profile allows amines to bind with CO₂ and then be regenerated on a periodic basis. The rise in temperature also increases the CO₂ permeability through the membrane, synergistically increasing the fraction and purity of CO₂ in the permeate. The magnitude of the temperature change as well as the optimal periodicity for the temperature change can be determined, thereby providing a means to compare performance of PDMS and amine-modified PDMS membranes. One example includes assessment of whether amine modification provides a reasonable increase in CO₂ capture per energy expended relative to the control PDMS membranes.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. In one example, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An additive-modified membrane comprising:
a functionalized siloxane, wherein the functionalized siloxane is cross-linked; and
an additive that modifies the structure of the functionalized siloxane,
wherein the additive-modified membrane is configured to capture gas molecules, the additive increases a solubility of the gas molecules in the additive-modified membrane, and increasing the solubility of the gas molecules in the additive-modified membrane comprises increasing the permselectivity of the additive-modified membrane.

2. The additive-modified membrane of claim 1, wherein the functionalized siloxane comprises: 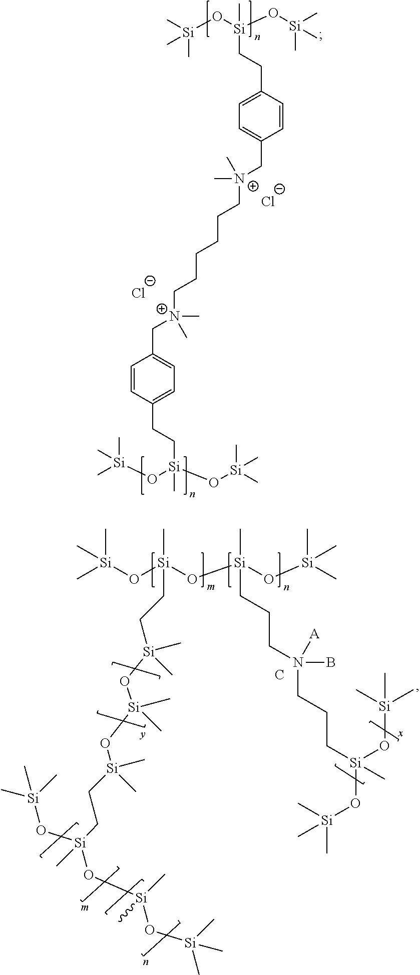
wherein A is hydrogen and B and C are not present, or
wherein A is a methyl group and B and C are not present, or
wherein A is a methyl group. B is a methyl group, and C is a counterion; 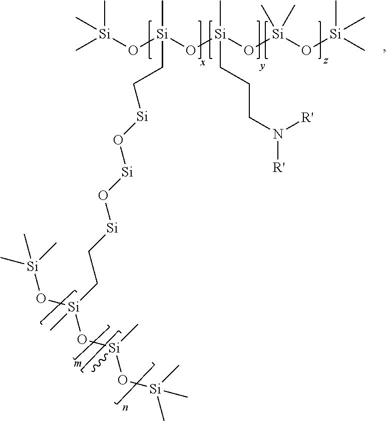
wherein each R′ independently comprises a methyl group or a hydrogen; 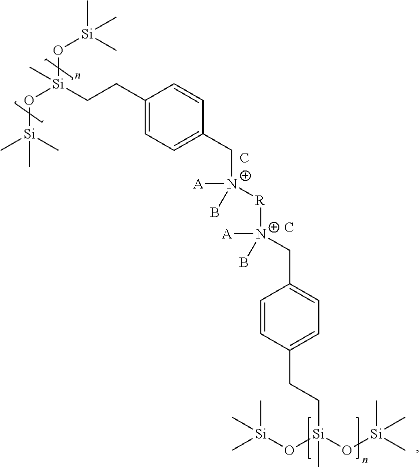
wherein R comprises 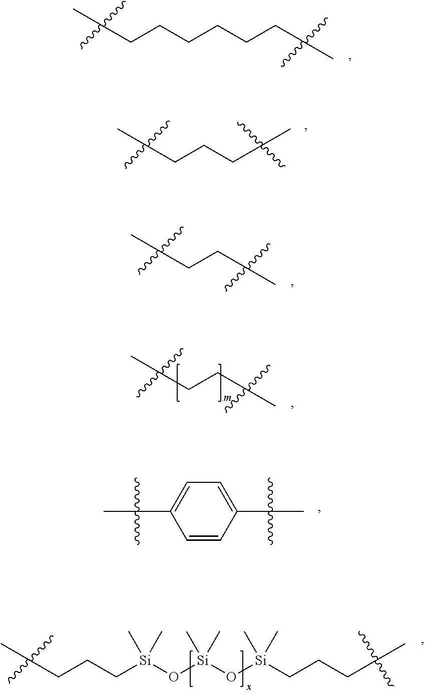
wherein A is hydrogen and B and C are not present, or
wherein A is a methyl group and B and C are not present, or
wherein A is a methyl group, B is a methyl group, and C is a counterion; 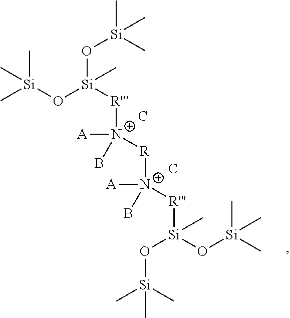
wherein R″ is 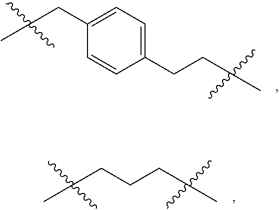
wherein A is hydrogen and B and C are not present, or
wherein A is a methyl group and B and C are not present, or
wherein A is a methyl group, B is a methyl group, and C is a counterion; 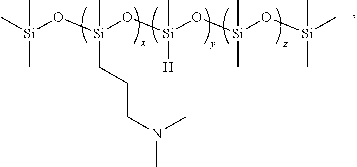
or any combination thereof,
wherein the counterion comprises a halide, a fluorinated anion, or an alkaline anion,
wherein the halide is Cl⁻, Br⁻, or I⁻,
wherein the fluorinated anion comprises 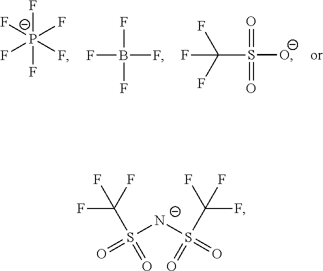
wherein the alkaline anion comprises OH⁻, HCO₃⁻, or CO₃⁻², and
wherein m, n, w, x, y, z are integers.

3. The additive-modified membrane of claim 1, wherein the functionalized siloxane comprises polydimethylsiloxane.

4. The additive-modified membrane of claim 1, wherein the functionalized siloxane comprises polymethylhydrosiloxane.

5. The additive-modified membrane of claim 1, wherein the functionalized siloxane comprises polydimethylsiloxane and polymethylhydrosiloxane.

6. The additive-modified membrane of claim 1, wherein the additive comprises an amine.

7. The additive-modified membrane of claim 6, wherein the amine comprises a tertiary amine.

8. The additive-modified membrane of claim 6, wherein the amine comprises a quaternary amine.

9. The additive-modified membrane of claim 6, wherein the amine comprises one or more of N,N,N′,N′-tetramethylhexane-1,6-diamine; vinyl-quaternary ammonium methacrylate siloxane; N,N-dimethylallylamine; quaternary ammonium methyl siloxane; or any combination thereof.

10. The additive-modified membrane of claim 1, wherein the gas molecules comprise CO₂.

11. The additive-modified membrane of claim 1, wherein the additive-modified membrane chemisorbs CO₂.

12. The additive-modified membrane of claim 1, wherein the additive-modified membrane is semipermeable.

13. A CO₂ capture system comprising:
the additive-modified membrane of claim 1; and
a CO₂ absorbent,
wherein the additive-modified membrane is in contact with the CO₂ absorbent.

14. The CO₂ capture system of claim 13, wherein the CO₂ absorbent is wrapped in the additive-modified membrane.

15. The CO₂ capture system of claim 13, wherein the CO₂ absorbent is in direct contact with the additive-modified membrane.

16. The CO₂ capture system of claim 13, wherein the CO₂ absorbent comprises an amine-based sorbent, soil, or a combination thereof.

17. The CO₂ capture system of claim 13, comprising a single stage configured to yield permeate concentrations of more than about 99.9% CO₂.

18. The CO₂ capture system of claim 13, comprising multiple stages configured to yield permeate concentrations of more than about 99.9% CO₂.

19. The CO₂ capture system of claim 13, comprising multiple single stages configured in parallel.

20. The CO₂ capture system of claim 13, comprising multiple single stages configured in series.
